(19) United States
(12) Patent Application Publication
(10) Pub. No.: US 2022/0262116 A1
(43) Pub. Date: Aug. 18, 2022

(54) Methods, Systems, And Apparatuses For Improved Video Frame Analysis And Classification

(71) Applicant: Comcast Cable Communications, LLC, Philadelphia, PA (US)

(72) Inventors: Mohammad Hosseini, Schaumburg, IL (US); Md Mahmudul Hasan, Arlington, VA (US)

(21) Appl. No.: 17/670,153

(22) Filed: Feb. 11, 2022

Related U.S. Application Data
(60) Provisional application No. 63/148,908, filed on Feb. 12, 2021.

(51) Int. Cl. G06V 20/40; G06V 10/56; G06T 7/00; G06V 10/764

(52) U.S. Cl. CPC G06V 20/41; G06V 10/56; G06T 2207/10024; G06V 10/764; G06T 2207/10016; G06T 7/0002

(57) ABSTRACT

Described herein are methods, systems, and apparatuses for improved video frame analysis and classification. A computer vision model may be trained to predict whether a video frame(s) depicts a particular object(s), event(s), or imagery using color features of the video frame(s). Another computer vision model may focus on grayscale features of the video frame(s) (e.g., black and white features) to verify the prediction when the grayscale features of the video frame(s) indicate the particular object(s), event(s), or imagery is depicted in the video frame(s).

### CROSS-REFERENCE TO RELATED PATENT APPLICATION

This application claims priority to U.S. Provisional Application No. 63/148,908, filed on Feb. 12, 2021, the entirety of which is incorporated by reference herein.

### BACKGROUND

Computer vision techniques may classify images and video as either depicting or not depicting particular objects, events, persons, etc. Adoption and use of these techniques has grown, and computer vision is now used to analyze complex images and video. The underlying classification models these techniques use have likewise grown in complexity. Such classification models require extensive memory and computational resources. Additionally, the increasingly complex images and videos being analyzed require large datasets to reduce false positives and other errors. These and other considerations are described herein.

### SUMMARY

It is to be understood that both the following general description and the following detailed description are exemplary and explanatory only and are not restrictive. A computer vision model may be trained to predict whether a video frame(s) depicts a particular object(s), event(s), or imagery using color features of the video frame(s). Another computer vision model may focus on grayscale features of the video frame(s) (e.g., black and white features) to verify the prediction when the grayscale features of the video frame(s) indicate the particular object(s), event(s), or imagery is depicted in the video frame(s). Other examples and configurations are possible. Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 shows an example system;

FIGS. 2A and 2B show example classification models;

FIG. 3 shows an example classification model;

FIG. 4 shows an example classification model;

FIGS. 5A-5D show example graphs;

FIG. 6 shows an example system;

FIG. 7 shows a flowchart for an example method;

FIG. 8 shows an example system;

FIG. 9 shows a flowchart for an example method;

FIG. 10 shows a flowchart for an example method;

FIG. 11 shows a flowchart for an example method;

FIG. 12 shows a flowchart for an example method; and

FIG. 13 shows a flowchart for an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium may be implemented. Any suitable computer-readable storage medium may be utilized including hard disks, CD-ROOIs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

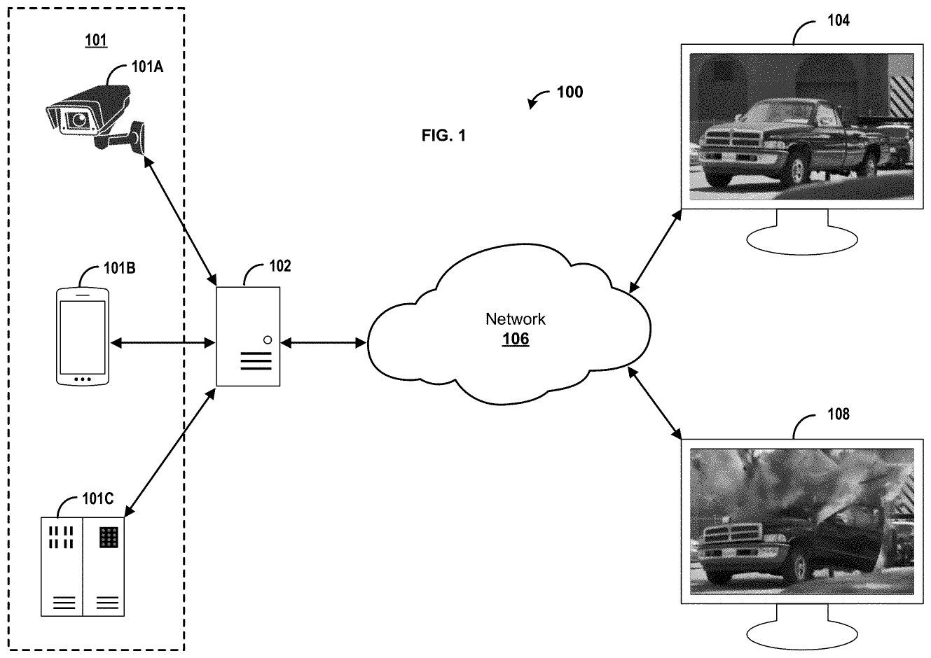

FIG. 1 shows an example system 100 for improved video frame analysis and classification. The system 100 may comprise a plurality of video sources 101, a server 102, a first user device 104, and a second user device 108. The plurality of video sources 101 may comprise any suitable device for capturing, storing, and/or sending images and/or video. For example, the plurality of video sources 101 may comprise a security camera 101A, a user device 101B, and a content provider server 101C. The security camera 101A may be any suitable camera, such as a still-image camera, a video camera, an infrared camera, a combination thereof, and/or the like. The user device 101B may be any be a mobile device, a computing device, a smart device, a combination thereof, and/or the like. The content provider server 101C may be an edge server, a central office server, a headend, a node server, a combination thereof, and/or the like.

The plurality of video sources 101 may send video (e.g., a plurality of images/frames) to the first user device 104 and/or the second user device 108 via a network 106. The network 106 may be configured to send the video to the first user device 104 and/or the second user device 108 using a variety of network paths, protocols, devices, and/or the like. The network 106 may be managed (e.g., deployed, serviced) by a content provider, a service provider, and/or the like. The network 106 may have a plurality of communication links connecting a plurality of devices. The network 106 may distribute signals from the plurality of video sources 101 to user devices, such as the first user device 104 or the second user device 108. The network 106 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof.

The first user device 104 and/or the second user device 108 may be a set-top box, a digital streaming device, a gaming device, a media storage device, a digital recording device, a computing device, a mobile computing device (e.g., a laptop, a smartphone, a tablet, etc.), a television, a projector, a combination thereof, and/or the like. The first user device 104 and/or the second user device 108 may implement one or more applications, such as content viewers, social media applications, news applications, gaming applications, content stores, electronic program guides, and/or the like. The server 102 may enable services related to video, content, and/or applications. The server 102 may have an application store. The application store may be configured to allow users to purchase, download, install, upgrade, and/or otherwise manage applications. The server 102 may be configured to allow users to download applications to a device, such as the first user device 104 and/or the second user device 108. The applications may enable a user of the first user device 104 and/or the second user device 108 to browse and select content items from a program guide, such as the video sent by the plurality of video sources 101.

The system 100 may be configured to analyze and classify one or more video frames sent by the plurality of video sources 101. For example, the system 100 may be configured to use machine learning and other artificial intelligence techniques (referred to collectively as “machine learning”) to analyze the one or more video frames and determine whether a particular object of interest (“OOI”), such as an object associated with a type of event or particular imagery, is depicted therein. The type of event may be an explosion, and the imagery may be a fire, a plume of smoke, glass shattering, a building collapsing, etc.

As further described herein, the system 100 may comprise a first classification model, such as a deep-learning model and/or a neural network. The first classification model may analyze a first frame of a plurality of frames of video sent by the plurality of video sources 101. The video may comprise footage captured by the security camera 101A, video clips captured/displayed by the user device 101B, a portion(s) of streaming or televised content associated with the content provider server 101C, a combination thereof, and/or the like. The first classification model may analyze color-based features of the first frame, such as features derived from color channels associated with the first frame. For example, the color channels may be indicative of red/green/blue (RGB) color channel values for each pixel depicted in the first frame. The first classification model may derive a plurality of color channel features based on the color channel and the RGB color channel values. The first classification model may determine a prediction that the OOI is present within the video frame based on the plurality of color channel features. The prediction may comprise a binary classification (e.g., “yes/no”), a percentage (e.g., 70%), a numerical value (e.g., 0.7), a combination thereof, and/or the like.

As further described herein, the system 100 may comprise a second classification model, such as a deep-learning model and/or a neural network. The second classification model may analyze grayscale-based features of the first frame. The grayscale-based features may be derived from a grayscale channel of the first frame. The grayscale channel may be indicative of patterns within the first frame and/or pixel intensity. The second classification model may transform the color channel and/or the color-based features of the first frame into a first plurality of grayscale channel features. The second classification model may analyze grayscale-based features of at least one neighboring frame of the plurality of frames. For example, the at least one neighboring frame may precede or follow the first frame (e.g., an adjacent frame). The second classification model may determine a second plurality of grayscale channel features based on a grayscale channel of the at least one neighboring frame

The prediction determined by the first classification model may be verified when a threshold is satisfied. For example, the second classification model may determine whether the first plurality of grayscale channel features are indicative of the OOI in the first frame, and the second classification model may determine whether the second plurality of grayscale channel features are indicative of the OOI in the at least one neighboring frame. The threshold may be satisfied (e.g., the prediction may be verified) when the first plurality of grayscale channel features are indicative of the OOI in the first frame and/or when the second plurality of grayscale channel features are indicative of the OOI in the at least one neighboring frame.

As shown in FIG. 1, the first user device 104 may show a video frame that depicts a truck. The server 102 and/or the first user device 104 may be configured to analyze the video frame to determine whether an OOI associated with an explosion is depicted in the video frame. The server 102 and/or the first user device 104 may determine that the video frame depicted by the first user device 104 does not depict the OOI. As another example, as shown in FIG. 1, the second user device 108 may show a video frame that depicts an explosion of a truck. The server 102 and/or the second user device 108 may be configured to analyze the video frame to determine whether an OOI associated with an explosion is depicted in the video frame. The server 102 and/or the second user device 108 may determine that the video frame depicted by the second user device 108 depicts the OOI. For example, as described herein, the server 102 and/or the second user device 108 may determine that the video frame depicted by the second user device 108 depicts the OOI based on a plurality of color-based features and/or a plurality of grayscale-based features.

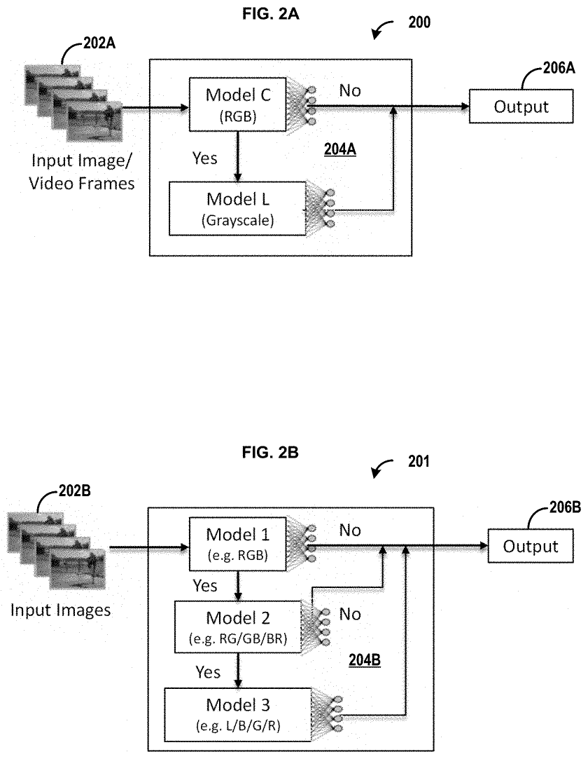

The machine learning techniques used by the system 100 may comprise at least one classification model that uses a verification-based combination of two or more deep-learning models. The at least one classification model may comprise the first classification model and/or the second classification model described herein. FIG. 2A shows an example classification model 200. The classification model 200 may comprise a classification module 204 comprising a Model C and a Model L. Model C of the classification module 204A may be a color-oriented model (e.g., a deep-learning model and/or a neural network) that focuses on color-based features of video frames/images that are analyzed. Model L of the classification module 204A may be a grayscale-oriented model (e.g., a deep-learning model and/or a neural network) that focuses on grayscale-based features of video frames/images that are analyzed.

The classification module 204A may analyze a video frame/image 202A (referred to herein as “video frame 202A”) and determine a prediction. The prediction may be indicative of an object of interest (“OOI”) being depicted (or not depicted) within the video frame 202A. The OOI may comprise an object associated with a type of event or particular imagery. For example, the type of event may be an explosion, and the imagery may be a fire, a plume of smoke, glass shattering, a building collapsing, etc. Model C of the classification module 204A may analyze the video frame 202A. The video frame 202A may comprise footage captured by a security camera, a frame of a video clip captured by a user device, a portion(s) of streaming or televised content, a combination thereof, and/or the like. Model C of the classification module 204A may analyze color-based features of the video frame 202A, such as features derived from color channels associated with the video frame 202A. For example, the color channels may be indicative of red/green/blue (RGB) color channel values for each pixel depicted in the video frame 202A. Model C of the classification module 204A may derive a plurality of color channel features based on the color channel and the RGB color channel values. Model C of the classification module 204A may determine a prediction that the OOI is present within the video frame 202A based on the plurality of color channel features. The prediction may comprise a binary classification (e.g., “yes/no”), a percentage (e.g., 70%), a numerical value (e.g., 0.7), a combination thereof, and/or the like. When Model C of the classification module 204A determines/predicts that the video frame 202A does not depict the OOI, an output 206A may be generated and indicate as much.

Model L of the classification module 204A may analyze grayscale-based features of the video frame 202A. The grayscale-based features may be derived from a grayscale channel of the video frame 202A. The grayscale channel may be indicative of patterns within the video frame 202A and/or pixel intensity. Model L of the classification module 204A may transform the color channel and/or the color-based features of the video frame 202A into a first plurality of grayscale channel features. The prediction determined by Model C of the classification module 204A may be verified. For example, Model L of the classification module 204A may determine whether the first plurality of grayscale channel features are indicative of the OOI in the video frame 202A. The prediction may be verified when the first plurality of grayscale channel features are indicative of the OOI in the video frame 202A. When the prediction is verified, the output 206A may comprise an indication that the video frame 202A depicts the OOI. For example, when the prediction is verified, the output 206A may comprise a binary classification (e.g., “yes/no”), a percentage (e.g., 70%), a numerical value (e.g., 0.7), a combination thereof, and/or the like. When the prediction is not verified, the output 206A may indicate as much.

FIG. 2B shows an example classification model 201. The classification model 201 may be similar to the classification model 200. The classification model 201 may comprise a classification module 204B comprising a Model 1, a Model 2, and a Model 3. Model 1 and Model 2 of the classification module 204B may each be a color-oriented model (e.g., a deep-learning model and/or a neural network) that focuses on color-based features of video frames/images that are analyzed. Model 1 of the classification module 204B may analyze all color-based features derived from color channels associated with a video frame 202B. For example, the color-based features may comprise red/green/blue (RGB) color channel values for each pixel within the video frame 202B. Model 2 of the classification module 204B may analyze a subset of the color-based features derived from the color channel associated with a video frame 202B. For example, the subset of the color-based features may comprise red-green, green-blue, or blue-red values for each pixel within the video frame 202B. Model 3 of the classification module 204B may be a grayscale-oriented model (e.g., a deep-learning model and/or a neural network) that focuses on grayscale-based features of the video frame 202B.

The classification module 204B may analyze the video frame 202B and determine a prediction. For example, Model 1 of the classification module 204B may determine a prediction that an OOIis present within the video frame 202B based on all of the color-based features derived from the color channels associated with the video frame 202B. The prediction may comprise a binary classification (e.g., “yes/no”), a percentage (e.g., 70%), a numerical value (e.g., 0.7), a combination thereof, and/or the like. When Model 1 of the classification module 204B determines/predicts that the video frame 202B does not depict the OOI, an output 206B may be generated and indicate as much. Model 2 of the classification module 204B may determine a prediction that the OOI is present within the video frame 202B based on the subset of the color-based features (e.g., red-green, green-blue, or blue-red values for each pixel) within the video frame 202B. The prediction may comprise a binary classification (e.g., “yes/no”), a percentage (e.g., 70%), a numerical value (e.g., 0.7), a combination thereof, and/or the like. When Model 2 of the classification module 204B determines/predicts that the video frame 202B does not depict the OOI, the output 206B may be generated and indicate as much.

When Model 2 of the classification module 204B determines/predicts that the video frame 202B depicts the OOI, the prediction determined by Model 1 of the classification module 204B may be verified. For example, the prediction determined by Model 1 of the classification module 204B may be verified when the prediction determined by the Model 2 of the classification module 204B indicates that the OOI is depicted in the video frame 202B. The prediction determined by Model 1 of the classification module 204B may be verified when a level of confidence associated with the prediction meets or exceeds (e.g., satisfies) a confidence threshold. For example, the prediction determined by Model 1 may comprise a first level of confidence (e.g., a percentage) that the OOI is depicted in the video frame 202B, and the prediction determined by Model 2 may comprise a second level of confidence (e.g., a percentage) that the OOI is depicted in the video frame 202B. The prediction determined by Model 1 may be verified when the first level of confidence and the second level of confidence both meet or exceed the confidence threshold (e.g., 70%). The prediction determined by Model 1 may be verified when the first level of confidence by itself meets or exceeds the confidence threshold. The prediction determined by Model 1 may be verified when the second level of confidence by itself meets or exceeds the confidence threshold. The prediction determined by Model 1 may not be verified when one or both of the first level of confidence or the second level of confidence fail to meet or exceed the confidence threshold. The confidence threshold may be the same for both models or may be different. Other combinations are contemplated.

Model 3 of the classification module 204B may analyze grayscale-based features of the video frame 202B. The grayscale-based features may be derived from a grayscale channel of the video frame 202B. The grayscale channel may be indicative of patterns within the video frame 202B and/or pixel intensity. Model 3 of the classification module 204B may transform the color channel and/or the color-based features of the video frame 202B into a plurality of grayscale channel features. The prediction determined by Model 2 of the classification module 204B, which may have verified the prediction determined by Model 1, may also be verified. For example, Model 3 of the classification module 204B may determine whether the plurality of grayscale channel features are indicative of the OOI in the video frame 202B. The prediction determined by Model 2 of the classification module 204B may be verified when the plurality of grayscale channel features are indicative of the OOI in the video frame 202B. When the prediction determined by Model 2 of the classification module 204B is verified, the output 206B may comprise an indication that the video frame 202B depicts the OOI. For example, when the prediction determined by Model 2 of the classification module 204B is verified, the output 206B may comprise a binary classification (e.g., “yes/no”), a percentage (e.g., 70%), a numerical value (e.g., 0.7), a combination thereof, and/or the like. When the prediction determined by Model 2 of the classification module 204B is not verified, the output 206B may indicate as much.

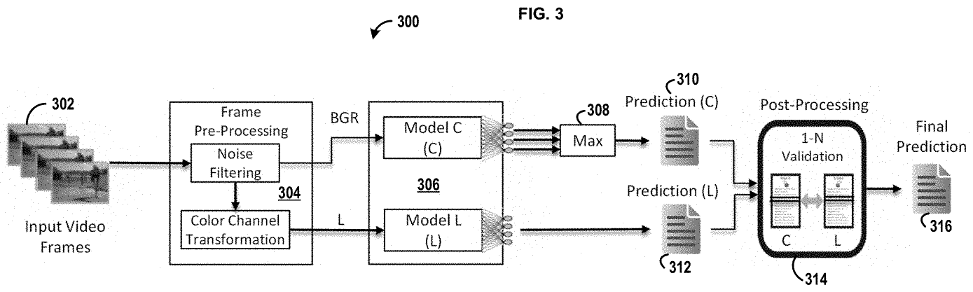

FIG. 3 shows an example classification model 300. The classification model 300 may comprise a pre-processing module 304. The pre-processing module may receive one or more video frames/images, such as a plurality of video frames 302. The plurality of video frames 302 may comprise footage captured by a security camera, a frame of a video clip captured by a user device, a portion(s) of streaming or televised content, a combination thereof, and/or the like. Each video frame of the plurality of video frames 302 may be resized by the pre-processing module 304. For example, the pre-processing module 304 may resize each video frame of the plurality of video frames 302 to 300×300 pixels. The pre-processing module 304 may perform noise filtering on each video frame of the plurality of video frames 302. For example, the pre-processing module 304 may perform noise filtering using an anti-aliasing technique. The pre-processing module 304 may extract color channels from each video frame of the plurality of video frames 302. The color channels may be indicative of red/green/blue (RGB) color channel values for each pixel of each video frame of the plurality of video frames 302. The pre-processing module 304 may comprise a color channel transformation module that transforms the color channels into a grayscale channel.

The classification model 300 may comprise a classification module 306. The classification module 306 may comprise one or more components of the classification models 200,201. For example, the classification module 306 may comprise a Model C and a Model L. Model C of the classification module 306 may be a color-oriented model (e.g., a deep-learning model and/or a neural network) that focuses on color-based features of the plurality of video frames 302. Model C of the classification module 204A may analyze the plurality of video frames 302 and derive a plurality of color channel features from the color channels associated with the plurality of video frames 302. For example, Model C of the classification module 306 may derive the plurality of color channel features based on the RGB color channel values for each pixel of each video frame of the plurality of video frames 302.

Model C of the classification module 306 may analyze a number of video frames selected from the plurality of video frames 302. For example, Model C of the classification module 306 may analyze 3 video frames selected from the plurality of video frames 302. The 3 video frames may or may not be successive frames within the plurality of video frames 302. Model C of the classification module 306 may analyze the 3 video frames and determine a prediction. The prediction may be indicative of an object of interest (“OOI”) being depicted (or not depicted) within each of the 3 video frames. The OOI may comprise an object associated with a type of event or particular imagery. For example, the type of event may be an explosion, and the imagery may be a fire, a plume of smoke, glass shattering, a building collapsing, etc. Model C of the classification module 306 may determine the prediction that the OOI is present within each video frame of the 3 video frames based on the plurality of color channel features corresponding to each of the 3 video frames. For example, a first frame of the 3 video frames may comprise a first set of RGB values, while a second frame of the 3 video frames may comprise a second set of RGB values that differ—at least partially—from the first set of RGB values. Each prediction for each of the 3 video frames determined by Model C of the classification module 306 may comprise a binary classification (e.g., “yes/no”), a percentage (e.g., 70%), a numerical value (e.g., 0.7), a combination thereof, and/or the like.

A mode of the predictions 308 may be determined by the classification module 306. For example, Model C of the classification module 306 may predict that the first frame and the second frame of the 3 video frames are indicative of the OOI (e.g., they both depict the OOI), and the prediction for the last frame of the 3 video frames may indicate that the last frame is not indicative of the OOI (e.g., the OOI is not depicted). The mode of the predictions 308 may therefore indicate that the OOI is depicted. The mode of the predictions 308 may be used to label/identify each of the 3 video frames as being indicative of the OOI, regardless of any individual prediction. For example, despite Model C of the classification module 306 having predicted that the last frame of the 3 video frames is not indicative of the OOI, the mode of the predictions 308 may override the prediction and the last frame may be labeled/identified as being indicative of the OOI. The classification module 306 may determine/generate a first prediction 310 for the 3 video frames. The first prediction 310 may be based on the mode of the predictions 308. For example, the first prediction 310 may indicate that each of the 3 video frames are indicative of the OOI.

Model L of the classification module 306 may be a grayscale-oriented model (e.g., a deep-learning model and/or a neural network) that focuses on grayscale-based features of each video frame of the plurality of video frames 302. The grayscale-based features of each video frame of the plurality of video frames 302 may be derived from the corresponding grayscale channels generated by the color channel transformation module described above. The grayscale channel of each video frame of the plurality of video frames 302 may be indicative of patterns and/or pixel intensity within each video frame of the plurality of video frames 302. Model L of the classification module 306 may determine a first plurality of grayscale channel features based on the grayscale channel corresponding to the first frame of the 3 video frames, a second plurality of grayscale channel features based on the grayscale channel corresponding to the second frame of the 3 video frames, a third plurality of grayscale channel features based on the grayscale channel corresponding to the last frame of the 3 video frames.

The classification module 300 may comprise a post-processing module 314. The post-processing module 314 may perform a 1-N validation on predictions determined by Model C of the classification module 300. For example, for every video frame i that may be labeled/associated with a prediction indicating the OOI is present (e.g., depicted in) the frame i (e.g., based on the mode of predictions 308), the prediction determined by Model L of the classification module 300 for the frame i and/or at least one neighboring frame may be used to verify the prediction indicating the OOI is present in the frame i. The at least one neighboring frame may be a preceding frame (e.g., i−1) or a next/following frame (e.g., i+1). The post-processing module 314 may validate/verify the prediction for frame i determined by Model C of the classification module 300 when the prediction determined by Model L of the classification module 300 for the frame i and/or the at least one neighboring frame indicate that the OOI is depicted.

Continuing with the example above, the post-processing module 314 may perform a 1−N validation on the predictions determined by Model C of the classification module 300 for the second frame of the 3 video frames. The post-processing module 314 may verify the prediction determined by Model C of the classification module 306 for the second frame of the 3 video frames based on the predictions determined by Model L of the classification module 306 for each of the 3 video frames. For example, Model L of the classification module 306 may determine that the first plurality of grayscale channel features are indicative of the OOI in the first frame, the second plurality of grayscale channel features are not indicative of the OOI in the second frame, and the third plurality of grayscale channel features are not indicative of the OOI in the third frame. The first plurality of grayscale channel features may be associated with the first frame of the 3 frames; however, the prediction determined by Model C of the classification module 306 for the second frame of the 3 video frames may nonetheless be verified by the post-processing module 314 based on Model L of the classification module 306 having determined that the first plurality of grayscale channel features are indicative of the OOI in the first frame. In other words, the prediction determined by Model C of the classification module 306 for the second frame of the 3 video frames may nonetheless be verified by the post-processing module 314 because Model L of the classification module 306 determined that the grayscale channel features for at least one neighboring frame of the second frame (e.g., the first frame) were indicative of the OOI.

The classification module 300 may determine/generate a final prediction 316. The final prediction 316 may indicate that the predictions determined by Model C of the classification module 300 for the 3 video frames has been validated/verified. For example, the final prediction 316 may indicate that the predictions determined by Model C of the classification module 300 for the 3 video frames are validated/verified when a threshold is satisfied. The threshold may be satisfied (e.g., the predictions for the 3 video frames may be verified) when the grayscale channel features associated with the at least one neighboring frame of the second frame are indicative of the OOI. The final prediction 316 may comprise a binary classification (e.g., “yes/no”), a percentage (e.g., 70%), a numerical value (e.g., 0.7), a combination thereof, and/or the like. When the prediction is not verified, the final prediction 316 may indicate as much. While the description of the classification module 300 and the post-processing module 314 describes 3 video frames being analyzed, it is to be understood that the number “3” is meant to be exemplary only rather than restrictive. For example, more than 3—or less than 3—of the plurality of video frames 302 may be analyzed.

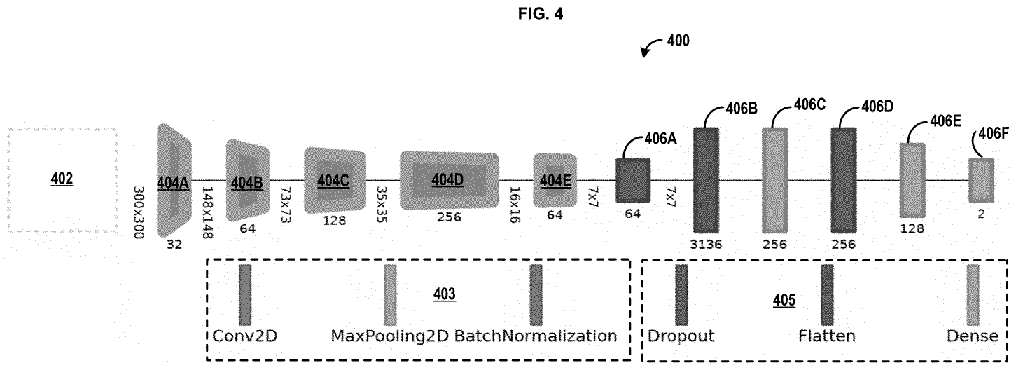

FIG. 4 shows an example neural network architecture 400. Each of the classification models 200,201,300 may comprise a deep-learning model comprising one or more portions of the neural network architecture 400. For example, Model C and Model L of the classification module 204A, Models 1-3 of the classification module 204B, and Model C and Model L of the classification module 306 may comprise one or more portions of the neural network architecture 400. The neural network architecture 400 may perform feature extraction, as described herein, on a plurality of video frames/images using a set of convolutional operations, which may comprise is a series of filters that are used to filter each video frame/image. The neural network architecture 400 may perform of a number of convolutional operations (e.g., feature extraction operations) followed by a number of fully-connected layers. The number of operations of each type and their corresponding sizes may be determined during a training phase as further described herein. The components of the neural network architecture 400 shown in FIG. 4 are meant to be exemplary only. The neural network architecture 400 may include additional components and/or layers, as one skilled in the art may appreciate.

The neural network architecture 400 may comprise the first set of layers 403 and/or the second set of layers 405 that may comprise a group of operations starting with a Convolution2D (Conv2D) or SeparableConvolution2D operation followed by zero or more operations (e.g., Pooling, Dropout, Activation, Normalization, BatchNormalization, other operations, or a combination thereof), until another convolutional layer, a Dropout operation, a Flatten Operation, a Dense layer, or an output of the model is reached. A Dense layer may comprise a group of operations or layers starting with a Dense operation (e.g., a fully connected layer) followed by zero or more operations (e.g., Pooling, Dropout, Activation, Normalization, BatchNormalization, other operations, or a combination thereof) until another convolution layer, another Dense layer, or the output of the network is reached. A boundary between feature extraction based on convolutional layers and a feature classification using Dense operations may be indicated by a Flatten operation, which may “flatten” a multidimensional matrix generated using feature extraction techniques into a vector. A Rectified Linear Unit (ReLU) function may be used by the neural network architecture 400 as an activation function for the Conv2D and Dense operations/layers. The neural network architecture 400 may comprise a variety of model architectures, such as a MobileNetV2 architecture, a SqueezeNet architecture, a ShuffleNet architecture, a combination thereof, and/or the like.

The neural network architecture 400 may comprise a first set of layers 403, a plurality of blocks 404A-404E, and a second set of layers 405. At each block of the plurality of blocks 404A-404E, an input video frame/image may be processed according to a particular kernel size (e.g., a number of pixels). The input video frame/image may be passed through a number of convolution filters comprising the first set of layers 403 at each block, and an output may then be passed through the second set of layers 405.

A first video frame/image 402 may be captured and resized to 300×300 pixels. For example, the block 404A may process the first video frame 402 comprising 300×300 pixels. The block 404A may comprise 32 convolution filters based on the first set of layers 403. The first video frame 402 may be processed at the block 404A using a kernel size of 148×148 pixels. The first video frame 402 may first pass through a Conv2D layer of the first set of layers 403 at the block 404A. The first video frame 402 may then pass through a MaxPooling2D layer of the first set of layers 403 at the block 404A. Finally, the first video frame402 may pass through a BatchNormalization layer of the first set of layers 403. The first video frame 402 may pass through the first set of layers 403 again at the blocks 404B-404E in a similar manner as the block 404A, except the number of convolution filters and the kernel size may vary—as shown in FIG. 4—at each of the blocks 404B-404E.

The BatchNormalization layer of the first set of layer 403 may standardize the video frame/image inputs as they are passed to each layer, which may accelerate training of the neural network architecture 400 reduce generalization errors. For example, at the second set of layers 405, the first video frames 402 may pass through a first Dropout layer 406A comprising 64 convolution layers that may apply a rate of dropout (e.g., 0.2) to prevent overfitting. A Flatten layer 406B of the second set of layers 405 may comprise 3,136 convolution filters—as shown in FIG. 4. The Flatten layer 406B of the second set of layers 405 may receive output features that are determined as a result of passing the first video frame 402 input video frames/images through the first set of layers 403. The output features may comprise a plurality of color-based features and a plurality of grayscale-based features. The Flatten layer 406B may determine/generate an N-dimensional array based on the output features. The array may passed to a next layer of the neural network architecture 400. For example, the array may then be passed through three Dense layers 406C,406E,406F, each having a different number of convolution layers (e.g., 256, 128, and 2), as well as a second Dropout layer 406D of the second set of layers 405. The second Dropout layer 406D may comprise 256 convolution layers. A result of passing the first frame 402 through the second set of layers 405 may be a final prediction for the first video frame 402. The final prediction may be indicative of whether the OOI is depicted in the first video frame 402. The final prediction may comprise a binary classification (e.g., “yes/no”), a percentage (e.g., 70%), a numerical value (e.g., 0.7), a combination thereof, and/or the like.

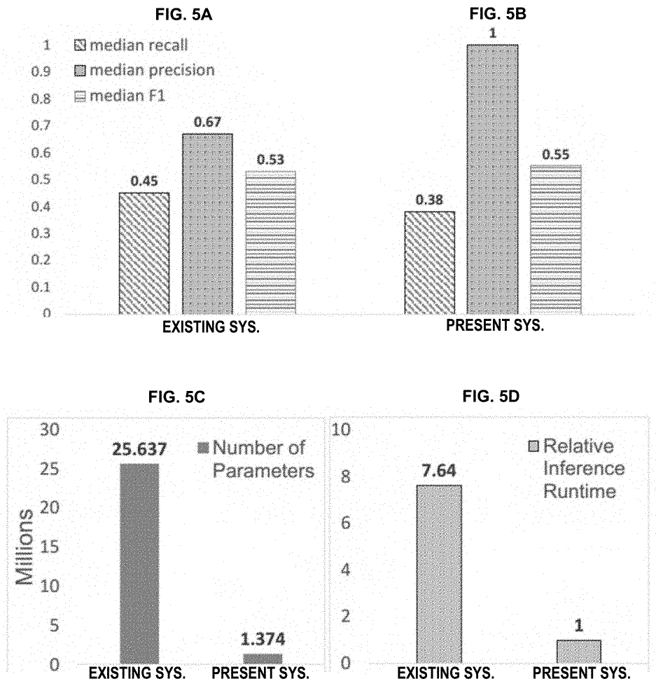

FIGS. 5A-5D show example graphs of results of using the machine learning techniques described herein. The machine learning techniques described herein were tested on a dataset of around 14,000 images that contained approximately 8,000 negative images (e.g., not depicting a particular OOI) and 6,000 positive images (e.g., depicting a particular OOI) from explosion footage. The dataset was split into training and validation/verification sets, with the validation/verification set comprising20% of the whole dataset. The machine learning techniques described herein (the “Present Sys.” in FIGS. 5A-5E) were compared against a popular existing system architecture (ResNet-50) (the “Existing Sys.” in FIGS. 5A-5E) on a set of 15 test videos of various contexts. The test videos included episodes of a popular TV series encoded in 720 p and 1080 p resolutions, with an average duration of around 52 minutes for each video and average number of 78,750 frames per video. Human operators inspected the videos in multiple rounds to provide ground truth data with the time intervals of where explosion happened, where an average of 10.75 distinct explosion scenes were recorded as ground truth for an average test video.

FIG. 5A shows a comparison of the median precision, recall, and F1 score metrics for the machine learning techniques described herein and the popular existing system architecture. FIG. 5C shows how the number of parameters and inference time of the machine learning techniques described herein compares with the existing system architecture. As shown in FIG. 5B, on an average video, the machine learning techniques described herein were able to achieve a 100% precision, which is significantly higher than the 67% precision made the existing system architecture. As shown in FIG. 5D, the machine learning techniques described herein may decrease an inference run-time by a large factor, almost 7.64× faster compared to the existing system architecture.

As described herein, the system 100 may use a variety of machine learning techniques when determining whether a video frame(s) depicts a particular OOI associated with a type of event or particular imagery. The classification models 200,201,300 described herein may comprise one or more ensemble models. Each of the one or more ensemble models may determine a prediction(s) regarding a presence of an OOI based on each color-based feature and each grayscale-based feature of one or more video frames/images. Each sub-model of the one or more ensemble models may be trained individually through variations in input data (e.g., video frames/images). The predictions determined by each of the one or more ensemble models may be considered as a vote, where all votes may be combined into a single, unified prediction and classification decision for a video frame. The one or more ensemble models may use voting, averaging, bagging, and/or boosting methods. For example, the one or more ensemble models may use a max-voting method where each individual model may determine a prediction and a vote for each sample (e.g., each color-based feature and each grayscale-based feature). A sample class with a highest number of votes (e.g., one or more color-based features and/or grayscale-based features) may be included in a final predictive class. The one or more ensemble models may use an averaging method where predictions from individual models are calculated for each sample. The one or more ensemble models may use bagging techniques where a variance of each ensemble model may be reduced by random-sampling and determining additional data in a training phase. The one or more ensemble models may use boosting methods where subsets of the input dataset (e.g., video frames/images) may be used to train multiple models that are then combined together in a specific way to boost the prediction.

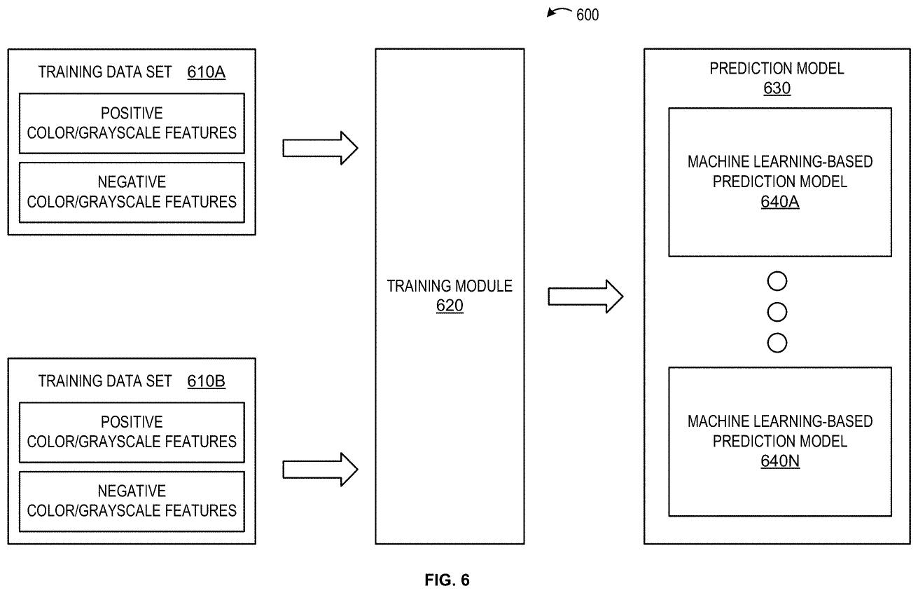

As discussed herein, the classification models 200,201,300 may each use one or more prediction models (e.g., an ensemble model/classifier). The prediction models, once trained, may be configured to determine whether a video frame(s)/image depicts or does not depict a particular OOI, a particular event, and/or particular imagery. The one or more prediction models used by each of the classification models 200,201,300 may be referred to herein as “at least one prediction model 630” or simply the “prediction model 630.” The at least one prediction model 630 may be trained by a system 600 as shown in FIG. 6.

The system 600 may be configured to use machine learning techniques to train, based on an analysis of one or more training datasets 610A-310B by a training module 620, the at least one prediction model 630. The at least one prediction model 630, once trained, may be configured to determine a prediction that an object of interest (“OOI”) is depicted or not depicted within a video frame(s)/image. The at least one prediction model 630 may comprise one or more deep-learning models comprising the neural network architecture 400 shown in FIG. 4.

A dataset indicative of a plurality of video frames/images and a labeled (e.g., predetermined/known) prediction regarding a particular OOI and each of the plurality of video frames/images may be used by the training module 620 to train the at least one prediction model 630. Each of the plurality of video frames/images in the dataset may be associated with one or more color-based/grayscale-based features of a plurality of color-based/grayscale-based features that are present within the video frame/image. The plurality of color-based/grayscale-based features and the labeled prediction for each of the plurality of video frames/images may be used to train the at least one prediction model 630.

The training dataset 610A may comprise a first portion of the plurality of video frames/images in the dataset. Each video frame/image in the first portion may have a labeled (e.g., predetermined) prediction and one or more labeled color-based/grayscale-based features present within the video frame/image. The training dataset 610B may comprise a second portion of the plurality of video frames/images in the dataset. Each video frame/image in the second portion may have a labeled (e.g., predetermined) prediction and one or more labeled color-based/grayscale-based features present within the video frame/image. The plurality of video frames/images may be randomly assigned to the training dataset 610A, the training dataset 610B, and/or to a testing dataset. In some implementations, the assignment of video frames/images to a training dataset or a testing dataset may not be completely random. In this case, one or more criteria may be used during the assignment, such as ensuring that similar numbers of video frames/images with different predictions and/or color-based/grayscale-based features are in each of the training and testing datasets. In general, any suitable method may be used to assign the video frames/images to the training or testing datasets, while ensuring that the distributions of predictions and/or color-based/grayscale-based features are somewhat similar in the training dataset and the testing dataset.

The training module 620 may use the first portion and the second portion of the plurality of video frames/images to determine one or more color-based/grayscale-based features that are indicative of a high prediction. That is, the training module 620 may determine which color-based/grayscale-based features present within the plurality of video frames/images are correlative with a high prediction. The one or more color-based/grayscale-based features indicative of a high prediction may be used by the training module 620 to train the prediction model 630. For example, the training module 620 may train the prediction model 630 by extracting a feature set (e.g., one or more color-based/grayscale-based features) from the first portion in the training dataset 610A according to one or more feature selection techniques. The training module 620 may further define the feature set obtained from the training dataset 610A by applying one or more feature selection techniques to the second portion in the training dataset 610B that includes statistically significant features of positive examples (e.g., high predictions) and statistically significant features of negative examples (e.g., low predictions). The training module 620 may train the prediction model 630 by extracting a feature set from the training dataset 610B that includes statistically significant features of positive examples (e.g., high predictions) and statistically significant features of negative examples (e.g., low predictions).

The training module 620 may extract a feature set from the training dataset 610A and/or the training dataset 610B in a variety of ways. For example, the training module 620 may extract a feature set from the training dataset 610A and/or the training dataset 610B using a classification module (e.g., the classification modules 204A, 204B,306). The training module 620 may perform feature extraction multiple times, each time using a different feature-extraction technique. In one example, the feature sets generated using the different techniques may each be used to generate different machine learning-based prediction models 640. For example, the feature set with the highest quality metrics may be selected for use in training. The training module 620 may use the feature set(s) to build one or more machine learning-based prediction models 640A-640N that are configured to determine a predicted prediction for a particular video frame/image.

The training dataset 610A and/or the training dataset 610B may be analyzed to determine any dependencies, associations, and/or correlations between color-based/grayscale-based features and the labeled predictions in the training dataset 610A and/or the training dataset 610B. The identified correlations may have the form of a list of color-based/grayscale-based features that are associated with different labeled predictions (e.g., depicting vs. not depicting a particular OOI). The color-based/grayscale-based features may be considered as features (or variables) in a machine learning context. The term “feature,” as used herein, may refer to any characteristic of an item of data that may be used to determine whether the item of data falls within one or more specific categories or within a range. By way of example, the features described herein may comprise one or more color-based features and/or grayscale-based features that may be correlative (or not correlative as the case may be) with a particular OOI depicted or not depicted within a particular video frame/image.

A feature selection technique may comprise one or more feature selection rules. The one or more feature selection rules may comprise a color-based/grayscale-based feature occurrence rule. The color-based/grayscale-based feature occurrence rule may comprise determining which color-based/grayscale-based features in the training dataset 610A occur over a threshold number of times and identifying those color-based/grayscale-based features that satisfy the threshold as candidate features. For example, any color-based/grayscale-based features that appear greater than or equal to 5 times in the training dataset 610A may be considered as candidate features. Any color-based/grayscale-based features appearing less than 5 times may be excluded from consideration as a feature. Other threshold numbers may be used as well.

A single feature selection rule may be applied to select features or multiple feature selection rules may be applied to select features. The feature selection rules may be applied in a cascading fashion, with the feature selection rules being applied in a specific order and applied to the results of the previous rule. For example, the color-based/grayscale-based feature occurrence rule may be applied to the training dataset 610A to generate a first list of color-based/grayscale-based features. A final list of candidate color-based/grayscale-based features may be analyzed according to additional feature selection techniques to determine one or more candidate color-based/grayscale-based feature groups (e.g., groups of color-based/grayscale-based features that may be used to determine a prediction). Any suitable computational technique may be used to identify the candidate color-based/grayscale-based feature groups using any feature selection technique such as filter, wrapper, and/or embedded methods. One or more candidate color-based/grayscale-based feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms used by the system 600. Instead, features may be selected on the basis of scores in various statistical tests for their correlation with the outcome variable (e.g., a prediction).

As another example, one or more candidate color-based/grayscale-based feature groups may be selected according to a wrapper method. A wrapper method may be configured to use a subset of features and train the prediction model 630 using the subset of features. Based on the inferences that may be drawn from a previous model, features may be added and/or deleted from the subset. Wrapper methods include, for example, forward feature selection, backward feature elimination, recursive feature elimination, combinations thereof, and the like. For example, forward feature selection may be used to identify one or more candidate color-based/grayscale-based feature groups. Forward feature selection is an iterative method that begins with no features. In each iteration, the feature which best improves the model is added until an addition of a new variable does not improve the performance of the model. As another example, backward elimination may be used to identify one or more candidate color-based/grayscale-based feature groups. Backward elimination is an iterative method that begins with all features in the model. In each iteration, the least significant feature is removed until no improvement is observed on removal of features. Recursive feature elimination may be used to identify one or more candidate color-based/grayscale-based feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more candidate color-based/grayscale-based feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the training module 620 has generated a feature set(s), the training module 620 may generate the one or more machine learning-based prediction models 640A-640N based on the feature set(s). A machine learning-based prediction model (e.g., any of the one or more machine learning-based prediction models 640A-640N) may refer to a complex mathematical model for data classification that is generated using machine-learning techniques as described herein. In one example, a machine learning-based prediction model may include a map of support vectors that represent boundary features. By way of example, boundary features may be selected from, and/or represent the highest-ranked features in, a feature set.

The training module 620 may use the feature sets extracted from the training dataset 610A and/or the training dataset 610B to build the one or more machine learning-based prediction models 640A-640N for each classification category (e.g., the OOI is depicted/present vs. the OOI is not depicted/present). In some examples, the one or more machine learning-based prediction models 640A-340N may be combined into a single machine learning-based prediction model 640 (e.g., an ensemble model). Similarly, the prediction model 630 may represent a single classifier containing a single or a plurality of machine learning-based prediction models 640 and/or multiple classifiers containing a single or a plurality of machine learning-based prediction models 640 (e.g., an ensemble classifier).

The extracted features (e.g., one or more candidate color-based/grayscale-based features) may be combined in the one or more machine learning-based prediction models 640A-640N that are trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting prediction model 630 may comprise a decision rule or a mapping for each candidate color-based/grayscale-based feature in order to assign a prediction to a class (e.g., depicted vs. not depicted). As described herein, the prediction model 630 may be used to determine predictions for video frame/images. The candidate color-based/grayscale-based features and the prediction model 630 may be used to determine predictions for video frame/images in the testing dataset (e.g., a third portion of the plurality of video frames/images).

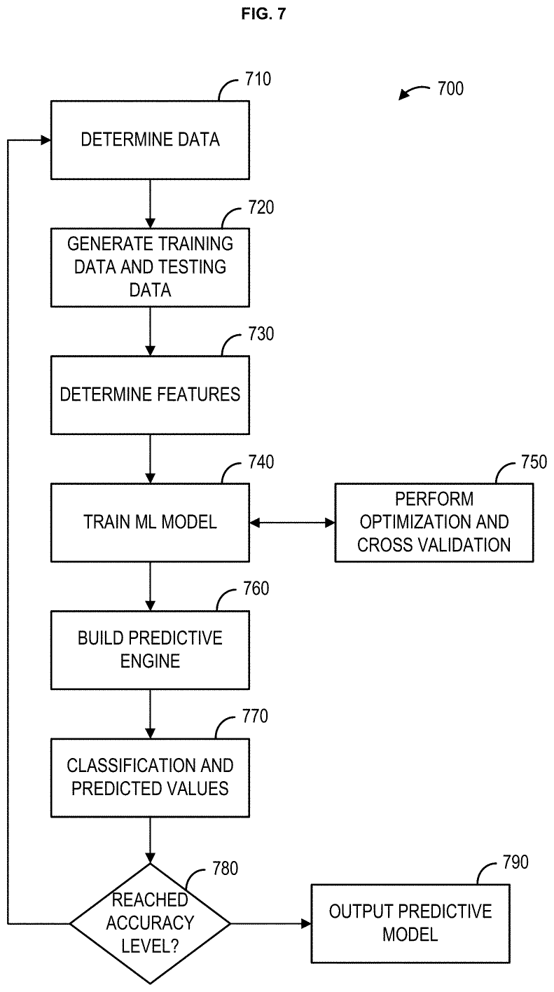

FIG. 7 is a flowchart illustrating an example training method 700 for generating the prediction model 630 using the training module 620. The training module 620 may implement supervised, unsupervised, and/or semi-supervised (e.g., reinforcement based) machine learning-based prediction models 640A-640N. The method 700 illustrated in FIG. 7 is an example of a supervised learning method; variations of this example of training method are discussed below, however, other training methods may be analogously implemented to train unsupervised and/or semi-supervised machine learning models. The method 700 may be implemented by the first user device 104, the second user device 108, and/or the server 102.

At step 710, the training method 700 may determine (e.g., access, receive, retrieve, etc.) first video frames/images and second video frames/images. The first video frames/images and the second video frames/images may each comprise one or more color-based/grayscale-based features and a predetermined prediction. The training method 700 may generate, at step 720, a training dataset and a testing dataset. The training dataset and the testing dataset may be generated by randomly assigning video frames/images from the first video frames/images and/or the second video frames/images to either the training dataset or the testing dataset. In some implementations, the assignment of video frames/images as training or test samples may not be completely random. As an example, only the video frames/images for a specific color-based/grayscale-based feature(s) and/or range(s) of predetermined predictions may be used to generate the training dataset and the testing dataset. As another example, a majority of the video frames/images for the specific color-based/grayscale-based feature(s) and/or range(s) of predetermined predictions may be used to generate the training dataset. For example, 75% of the video frames/images for the specific color-based/grayscale-based feature(s) and/or range(s) of predetermined predictions may be used to generate the training dataset and 25% may be used to generate the testing dataset.

The training method 700 may determine (e.g., extract, select, etc.), at step 730, one or more features that may be used by, for example, a classifier to differentiate among different classifications (e.g., predictions). The one or more features may comprise a set of color-based/grayscale-based features. As an example, the training method 700 may determine a set features from the first video frames/images. As another example, the training method 700 may determine a set of features from the second video frames/images. In a further example, a set of features may be determined from other video frames/images of the plurality of video frames/images (e.g., a third portion) associated with a specific color-based/grayscale-based feature(s) and/or range(s) of predetermined predictions that may be different than the specific color-based/grayscale-based feature(s) and/or range(s) of predetermined predictions associated with the video frames/images of the training dataset and the testing dataset. In other words, the other video frames/images (e.g., the third portion) may be used for feature determination/selection, rather than for training. The training dataset may be used in conjunction with the other video frames/images to determine the one or more features. The other video frames/images may be used to determine an initial set of features, which may be further reduced using the training dataset.

The training method 700 may train one or more machine learning models (e.g., one or more prediction models, neural networks, deep-learning models, etc.) using the one or more features at step 740. In one example, the machine learning models may be trained using supervised learning. In another example, other machine learning techniques may be used, including unsupervised learning and semi-supervised. The machine learning models trained at step 740 may be selected based on different criteria depending on the problem to be solved and/or data available in the training dataset. For example, machine learning models may suffer from different degrees of bias. Accordingly, more than one machine learning model may be trained at 740, and then optimized, improved, and cross-validated at step 750.

The training method 700 may select one or more machine learning models to build the prediction model 630 at step 760. The prediction model 630 may be evaluated using the testing dataset. The prediction model 630 may analyze the testing dataset and generate classification values and/or predicted values (e.g., predictions) at step 770. Classification and/or prediction values may be evaluated at step 780 to determine whether such values have achieved a desired accuracy level. Performance of the prediction model 630 may be evaluated in a number of ways based on a number of true positives, false positives, true negatives, and/or false negatives classifications of the plurality of data points indicated by the prediction model 630.

For example, the false positives of the prediction model 630 may refer to a number of times the prediction model 630 incorrectly assigned a high prediction to a video frame/image associated with a low predetermined prediction. Conversely, the false negatives of the prediction model 630 may refer to a number of times the machine learning model assigned a low prediction to a video frame/image associated with a high predetermined prediction. True negatives and true positives may refer to a number of times the prediction model 630 correctly assigned predictions to video frames/images based on the known, predetermined prediction for each video frame/image. Related to these measurements are the concepts of recall and precision. Generally, recall refers to a ratio of true positives to a sum of true positives and false negatives, which quantifies a sensitivity of the prediction model 630. Similarly, precision refers to a ratio of true positives a sum of true and false positives.When such a desired accuracy level is reached, the training phase ends and the prediction model 630 may be output at step 790; when the desired accuracy level is not reached, however, then a subsequent iteration of the training method 700 may be performed starting at step 610 with variations such as, for example, considering a larger collection of video frames/images. The prediction model 630 may be output at step 790. The prediction model 630 may be configured to determine predicted predictions for video frames/images that are not within the plurality of video frames/images used to train the prediction model.

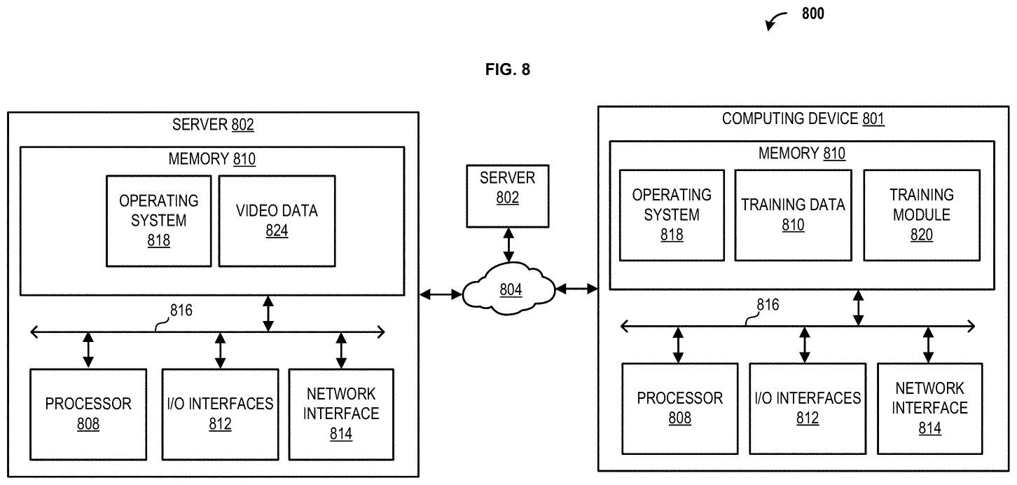

As discussed herein, the present methods and systems may be computer-implemented. FIG. 8 shows a block diagram depicting an environment 800 comprising non-limiting examples of a computing device 801 and a server 802 connected through a network 804, such as the network 106. The computing device 801 and/or the server 802 may be any one of the first user device 104, the second user device 108, the server 102, and/or the plurality of sources 101 of FIG. 1. In an aspect, some or all steps of any described method herein may be performed on a computing device as described herein. The computing device 801 may comprise one or multiple computers configured to store one or more of the training module 820, training data 810, and the like. The server 802 may comprise one or multiple computers configured to store video data 824 (e.g., a plurality of video frames and associated color-based and grayscale-based features). Multiple servers 802 may communicate with the computing device 801 via the through the network 804.

The computing device 801 and the server 802 may each be a digital computer that, in terms of hardware architecture, generally includes a processor 808, memory system 810, input/output (I/O) interfaces 812, and network interfaces 814. These components (608, 810, 812, and 814) are communicatively coupled via a local interface 816. The local interface 816 may be, for example, but not limited to, one or more buses or other wired or wireless connections, as is known in the art. The local interface 816 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 808 may be a hardware device for executing software, particularly that stored in memory system 810. The processor 808 may be any custom made or commercially available processor, a central processing unit (CPU), an auxiliary processor among several processors associated with the computing device 801 and the server 802, a semiconductor-based microprocessor (in the form of a microchip or chip set), or generally any device for executing software instructions. When the computing device 801 and/or the server 802 is in operation, the processor 808 may be configured to execute software stored within the memory system 810, to communicate data to and from the memory system 810, and to generally control operations of the computing device 801 and the server 802 pursuant to the software.

The I/O interfaces 812 may be used to receive user input from, and/or for providing system output to, one or more devices or components. User input may be received via, for example, a keyboard and/or a mouse. System output may comprise a display device and a printer (not shown). I/O interfaces 812 may include, for example, a serial port, a parallel port, a Small Computer System Interface (SCSI), an infrared (IR) interface, a radio frequency (RF) interface, and/or a universal serial bus (USB) interface.

The network interface 814 may be used to transmit and receive from the computing device 801 and/or the server 802 on the network 804. The network interface 814 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi, cellular, satellite), or any other suitable network interface device. The network interface 814 may include address, control, and/or data connections to enable appropriate communications on the network 804.

The memory system 810 may include any one or combination of volatile memory elements (e.g., random access memory (RAM, such as DRAM, SRAM, SDRAM, etc.)) and nonvolatile memory elements (e.g., ROOI, hard drive, tape, CDROOI, DVDROM, etc.). Moreover, the memory system 810 may incorporate electronic, magnetic, optical, and/or other types of storage media. Note that the memory system 810 may have a distributed architecture, where various components are situated remote from one another, but may be accessed by the processor 808.

The software in memory system 810 may include one or more software programs, each of which comprises an ordered listing of executable instructions for implementing logical functions. In the example of FIG. 8, the software in the memory system 810 of the computing device 801 may comprise the training module 320 (or subcomponents thereof), the training data 320, and a suitable operating system (O/S) 818. In the example of FIG. 8, the software in the memory system 810 of the server 802 may comprise, the video data 824, and a suitable operating system (O/S) 818. The operating system 818 essentially controls the execution of other computer programs and provides scheduling, input-output control, file and data management, memory management, and communication control and related services.

For purposes of illustration, application programs and other executable program components such as the operating system 818 are illustrated herein as discrete blocks, although it is recognized that such programs and components may reside at various times in different storage components of the computing device 801 and/or the server 802. An implementation of the training module 320 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

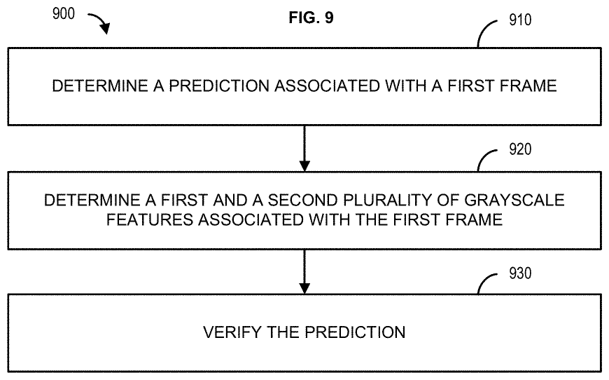

FIG. 9 shows a flowchart of an example method 900 for improved video frame analysis and classification. The method 900 may be performed in whole or in part by a single computing device, a plurality of computing devices, and the like. For example, the first user device 104, the second user device 108, the server 102, the computing device 801, and/or the server 802 may be configured to perform the method 900.

The method 900 may use a classification model to predict whether a first frame of a plurality of video frames comprises an object of interest (“OOI”). A computing device may receive the plurality of video frames. For example, a pre-processing module of the classification model may receive the plurality of video frames. The plurality of video frames may comprise footage captured by a security camera, a frame of a video clip captured by a user device, a portion(s) of streaming or televised content, a combination thereof, and/or the like. Each video frame of the plurality of video frames may be resized by the pre-processing module. For example, the pre-processing module may resize each video frame of the plurality of video frames to 300×300 pixels. The pre-processing module may perform noise filtering on each video frame of the plurality of video frames. For example, the pre-processing module may perform noise filtering using an anti-aliasing technique. The pre-processing module may extract color channels from each video frame of the plurality of video frames. The color channels may be indicative of red/green/blue (RGB) color channel values for each pixel of each video frame of the plurality of video frames. The pre-processing module may comprise a color channel transformation module that transforms the color channels into a grayscale channel.

The classification model may comprise a classification module. The classification module may comprise a first classification model and a second classification model. The first classification model may be a color-oriented model (e.g., a deep-learning model and/or a neural network) that focuses on color-based features of the plurality of video frames. The first classification model may analyze the plurality of video frames and derive a plurality of color channel features from the color channels associated with the plurality of video frames. For example, the first classification model may derive the plurality of color channel features based on the RGB color channel values for each pixel of each video frame of the plurality of video frames.

The first classification model may analyze a number of video frames selected from the plurality of video frames. For example, the first classification model of the classification module may analyze 3 video frames selected from the plurality of video frames. The 3 video frames may or may not be successive frames within the plurality of video frames. At step 910, the first classification model may determine a first prediction associated with a first frame of the plurality of frames. The first frame may be in a second—or middle—position in the plurality of frames in terms of order. The prediction may be indicative of an object of interest (“OOI”) being depicted (or not depicted) within the first frame. The OOI may comprise an object associated with a type of event or particular imagery. For example, the type of event may be an explosion, and the imagery may be a fire, a plume of smoke, glass shattering, a building collapsing, etc. The first classification model may determine the first prediction based on the plurality of color channel features corresponding to the first frame. The first classification model may determine a similar prediction regarding the OOI for each of the other frames of the plurality of frames. Each prediction determined by the first classification model may comprise a binary classification (e.g., “yes/no”), a percentage (e.g., 70%), a numerical value (e.g., 0.7), a combination thereof, and/or the like.

A mode of the predictions may be determined by the computing device. For example, the first classification model may predict that a frame preceding the first frame and the first frame itself are both indicative of the OOI (e.g., they both depict the OOI). The prediction for a last frame of the 3 video frames may indicate that the last frame is not indicative of the OOI (e.g., the OOI is not depicted). The mode of the predictions may therefore indicate that the OOI is depicted in the group of 3 video frames. The mode of the predictions may be used to label/identify each of the 3 video frames as being indicative of the OOI, regardless of any individual prediction.

The second classification model be a grayscale-oriented model (e.g., a deep-learning model and/or a neural network) that focuses on grayscale-based features of each video frame of the plurality of video frames. The grayscale-based features of each video frame of the plurality of video frames may be derived from the corresponding grayscale channels generated by a color channel transformation module of the computing device. The grayscale channel of each video frame of the plurality of video frames may be indicative of patterns and/or pixel intensity within each video frame of the plurality of video frames. At step 920, the computing device may determine a first plurality of grayscale channel features associated with the first frame and a second plurality of grayscale channel features associated with the first frame. For example, the computing device (e.g., the second classification model) may determine the first plurality of grayscale channel features based on the grayscale channel corresponding to the first frame. The computing device may determine the second plurality of grayscale channel features for at least one neighboring frame of the first frame. The second classification model may determine the second plurality of grayscale channel features based on the grayscale channel corresponding to the frame that precedes first frame and/or the grayscale channel corresponding to the last frame.

The computing device may comprise a post-processing module. The post-processing module may perform a 1-N validation on predictions determined by the first classification model. For example, the post-processing module may perform a 1-N validation on the predictions determined by the first classification model for the first frame. The post-processing module may verify the prediction determined by the first classification model for the first frame of based on the predictions determined by the second classification model for each of the 3 video frames. The prediction determined by the first classification model for the first frame of may be verified by the post-processing module based on the second classification model having determined that the first plurality of grayscale channel features and/or the second plurality of grayscale channel features are indicative of the OOI. In other words, the prediction determined the first classification model for the first frame may nonetheless be verified by the post-processing module because the second classification model determined that the grayscale channel features for at least one neighboring frame were indicative of the OOI.

The computing device may determine/generate a final prediction. The final prediction may indicate that the predictions determined by the first classification model have been validated/verified. For example, the final prediction may indicate that the predictions determined by the first classification model for the 3 video frames are validated/verified when a threshold is satisfied. The final prediction may comprise a binary classification (e.g., “yes/no”), a percentage (e.g., 70%), a numerical value (e.g., 0.7), a combination thereof, and/or the like.

At step 930, the computing device may verify the first prediction. For example, the computing device may determine that the first prediction satisfies the threshold. For example, the threshold may be satisfied (e.g., the predictions for the 3 video frames may be verified) when the grayscale channel features associated with the at least one neighboring frame of the first frame are indicative of the OOI. In some examples the first prediction may comprise a first level of confidence (e.g., a percentage) that the OOI is depicted in the first frame, and the first and/or second plurality of grayscale channel features may be associated with a second level of confidence (e.g., a percentage) that the OOI is depicted in the first frame. The first prediction may be verified when the first level of confidence and the second level of confidence both meet or exceed the threshold (e.g., a confidence threshold of 70%). The first prediction may be verified when the first level of confidence by itself meets or exceeds the confidence threshold. The first prediction may be verified when the second level of confidence by itself meets or exceeds the confidence threshold. The first prediction may not be verified when one or both of the first level of confidence or the second level of confidence fail to meet or exceed the confidence threshold. The confidence threshold may be the same for both models or may be different. Other combinations are contemplated.

Though the method 900 is described herein with the first classification model being a color-oriented model and the second classification model being a grayscale-oriented model, it is to be understood that the first classification model may be a grayscale-oriented model and the second classification model may be a color-oriented model. In such examples the method 900 may proceed in a similar manner as described above, except that the first prediction at step 910 may be based on grayscale channel features rather than color channel features, the plurality of grayscale channel features associated with the first frame may instead be a plurality of color features associated with the first frame, and so forth.

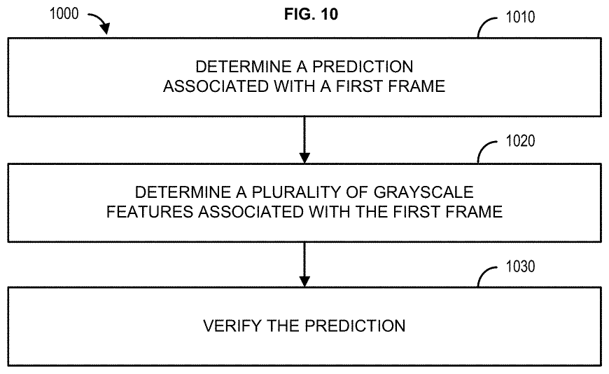

FIG. 10 shows a flowchart of an example method 1000 for improved video frame analysis and classification. The method 1000 may be performed in whole or in part by a single computing device, a plurality of computing devices, and the like. For example, the first user device 104, the second user device 108, the server 102, the computing device 801, and/or the server 802 may be configured to perform the method 1000.

The method 1000 may use a classification model to predict whether a first video frame or image (referred to herein as a “first frame”) of a plurality of video frames/images comprises an object of interest (“OOI”). A computing device may receive the first frame. The computing device may comprise at least one classification module that uses a verification-based combination of two or more deep-learning models. For example, the classification module may comprise a first classification model and a second classification model. The first classification model may be a color-oriented model (e.g., a deep-learning model and/or a neural network) that focuses on color-based features of video frames/images that are analyzed. The second classification model may be a grayscale-oriented model (e.g., a deep-learning model and/or a neural network) that focuses on grayscale-based features of video frames/images that are analyzed.

At step 1010, the computing device may determine a prediction associated with the first frame. The prediction may be indicative of an object of interest (“OOI”) being depicted (or not depicted) within the first frame. The OOI may comprise an object associated with a type of event or particular imagery. For example, the type of event may be an explosion, and the imagery may be a fire, a plume of smoke, glass shattering, a building collapsing, etc. The first classification model may analyze the first frame. The first frame may comprise footage captured by a security camera, a frame of a video clip captured by a user device, a portion(s) of streaming or televised content, a combination thereof, and/or the like. The first classification model may analyze color-based features of the first frame, such as features derived from color channels associated with the first frame. For example, the color channels may be indicative of red/green/blue (RGB) color channel values for each pixel depicted in the first frame. The first classification model may derive a plurality of color channel features based on the color channel and the RGB color channel values. The first classification model may determine a prediction that the OOI is present within the first frame based on the plurality of color channel features. The prediction may comprise a binary classification (e.g., “yes/no”), a percentage (e.g., 70%), a numerical value (e.g., 0.7), a combination thereof, and/or the like.

The second classification model may analyze grayscale-based features of the first frame. The grayscale-based features may be derived from a grayscale channel of the first frame. The grayscale channel may be indicative of patterns within the first frame and/or pixel intensity. At step 1020, the computing device may determine a plurality of grayscale channel features associated with the first frame. For example, the second classification model may transform the color channel and/or the color-based features of the first frame into the plurality of grayscale channel features. At step 1030, the prediction may be verified. For example, the prediction determined by the first classification module may be verified. The first classification module may determine whether the plurality of grayscale channel features are indicative of the OOI in the first frame. The prediction may be verified when the plurality of grayscale channel features are indicative of the OOI in the first frame.

In some examples the prediction at step 1010 may comprise a first level of confidence (e.g., a percentage) that the OOI is depicted in the first frame, and the plurality of grayscale channel features may be associated with a second level of confidence (e.g., a percentage) that the OOI is depicted in the first frame. The prediction may be verified when the first level of confidence and the second level of confidence both meet or exceed the threshold (e.g., a confidence threshold of 70%). The prediction may be verified when the first level of confidence by itself meets or exceeds the confidence threshold. The prediction may be verified when the second level of confidence by itself meets or exceeds the confidence threshold. The prediction may not be verified when one or both of the first level of confidence or the second level of confidence fail to meet or exceed the confidence threshold. The confidence threshold may be the same for both models or may be different. Other combinations are contemplated.

Though the method 1000 is described herein with the first classification model being a color-oriented model and the second classification model being a grayscale-oriented model, it is to be understood that the first classification model may be a grayscale-oriented model and the second classification model may be a color-oriented model. In such examples the method 1000 may proceed in a similar manner as described above, except that the prediction at step 1010 may be based on grayscale channel features rather than color channel features, the plurality of grayscale channel features associated with the first frame may instead be a plurality of color features associated with the first frame, and so forth.

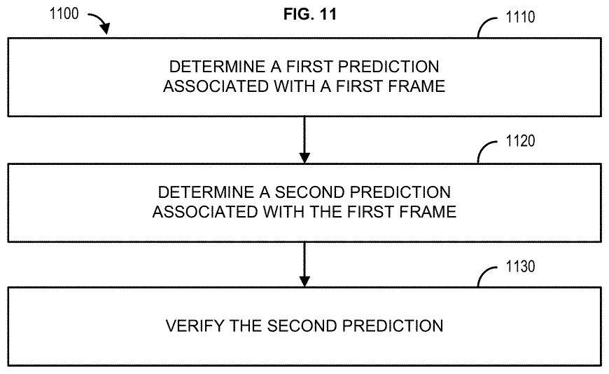

FIG. 11 shows a flowchart of an example method 1100 for improved video frame analysis and classification. The method 1100 may be performed in whole or in part by a single computing device, a plurality of computing devices, and the like. For example, the first user device 104, the second user device 108, the server 102, the computing device 801, and/or the server 802 may be configured to perform the method 1100.

The method 1100 may use a classification model to predict whether a first video frame or image (referred to herein as a “first image”) of a plurality of video frames/images comprises an object of interest (“OOI”). A computing device may receive the first image. The computing device may comprise a classification module. The classification module may comprise a first classification model, a second classification model, and a third classification model. The first and second classification models may each be a color-oriented model (e.g., a deep-learning model and/or a neural network) that focuses on color-based features of video frames/images that are analyzed. The first classification model may analyze all color-based features derived from color channels associated with the first image. For example, the color-based features may comprise red/green/blue (RGB) color channel values for each pixel within the first image. The second classification model may analyze a subset of the color-based features derived from the color channel associated with the first image. For example, the subset of the color-based features may comprise red-green, green-blue, or blue-red values for each pixel within the first image. The third classification model may be a grayscale-oriented model (e.g., a deep-learning model and/or a neural network) that focuses on grayscale-based features of the first image.

At step 1110, the computing device may determine a first prediction associated with the first image. For example, the first classification model may determine a prediction that an OOI is present within the first image based on all of the color-based features derived from the color channels associated with the first image. The prediction may comprise a binary classification (e.g., “yes/no”), a percentage (e.g., 70%), a numerical value (e.g., 0.7), a combination thereof, and/or the like. At step 1120, the computing device may determine a second prediction associated with the first image. For example, the second classification model may determine a prediction that the OOI is present within the first image based on the subset of the color-based features (e.g., red-green, green-blue, or blue-red values for each pixel) within the first image. The second prediction may comprise a binary classification (e.g., “yes/no”), a percentage (e.g., 70%), a numerical value (e.g., 0.7), a combination thereof, and/or the like. The first prediction determined by the first classification model may be verified when the prediction determined by the second model indicates that the OOI is depicted in the first image.

At step 1130, the computing device may verify the second prediction (e.g., determine that the second prediction is verified). For example, the third model may analyze grayscale-based features of the first image and determine that the second prediction is verified (e.g., validated). The grayscale-based features may be derived from a grayscale channel of the first image. The grayscale channel may be indicative of patterns within the first image and/or pixel intensity. The third classification model may transform the color channel and/or the color-based features of the first image into a plurality of grayscale channel features. The third classification model may determine whether the plurality of grayscale channel features are indicative of the OOI in the first image. The second prediction may be verified when the plurality of grayscale channel features are indicative of the OOI in the first image.

Though the method 1100 is described herein with the first and second classification models being color-oriented models and the third classification model being a grayscale-oriented model, it is to be understood that the first and second classification models may be grayscale-oriented models and the third classification model may be a color-oriented model. In such examples the method 1100 may proceed in a similar manner as described above, except that the prediction at step 1010 may be based on grayscale channel features rather than color channel features, the second classification model may determine a prediction that the OOI is present within the first image based on a subset of grayscale-based features within the first image, and so forth.

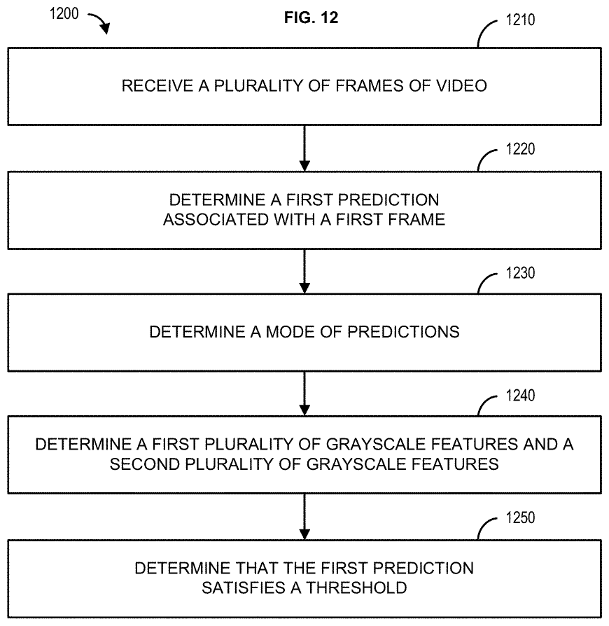

FIG. 12 shows a flowchart of an example method 1200 for improved video frame analysis and classification. The method 1200 may be performed in whole or in part by a single computing device, a plurality of computing devices, and the like. For example, the first user device 104, the second user device 108, the server 102, the computing device 801, and/or the server 802 may be configured to perform the method 1200.

The method 1200 may use a classification model to predict whether a first frame of a plurality of video frames comprises an object of interest (“OOI”). At step 1210, a computing device may receive the plurality video frames. For example, a pre-processing module of the classification model may receive the plurality of video frames. The plurality of video frames may comprise footage captured by a security camera, a frame of a video clip captured by a user device, a portion(s) of streaming or televised content, a combination thereof, and/or the like. Each video frame of the plurality of video frames may be resized by the pre-processing module. For example, the pre-processing module may resize each video frame of the plurality of video frames to 300×300 pixels. The pre-processing module may perform noise filtering on each video frame of the plurality of video frames. For example, the pre-processing module may perform noise filtering using an anti-aliasing technique. The pre-processing module may extract color channels from each video frame of the plurality of video frames. The color channels may be indicative of red/green/blue (RGB) color channel values for each pixel of each video frame of the plurality of video frames. The pre-processing module may comprise a color channel transformation module that transforms the color channels into a grayscale channel.

The classification model may comprise a classification module. The classification module may comprise a first classification model and a second classification model. The first classification model may be a color-oriented model (e.g., a deep-learning model and/or a neural network) that focuses on color-based features of the plurality of video frames. The first classification model may analyze the plurality of video frames and derive a plurality of color channel features from the color channels associated with the plurality of video frames. For example, the first classification model may derive the plurality of color channel features based on the RGB color channel values for each pixel of each video frame of the plurality of video frames.

The first classification model may analyze a number of video frames selected from the plurality of video frames. For example, the first classification model of the classification module may analyze 3 video frames selected from the plurality of video frames. The 3 video frames may or may not be successive frames within the plurality of video frames. At step 1220, the first classification model may determine a first prediction associated with a first frame of the plurality of frames. The first frame may be in a second—or middle—position in the plurality of frames in terms of order. The prediction may be indicative of an object of interest (“OOI”) being depicted (or not depicted) within the first frame. The OOI may comprise an object associated with a type of event or particular imagery. For example, the type of event may be an explosion, and the imagery may be a fire, a plume of smoke, glass shattering, a building collapsing, etc. The first classification model may determine the first prediction based on the plurality of color channel features corresponding to the first frame. The first classification model may determine a similar prediction regarding the OOI for each of the other frames of the plurality of frames. Each prediction determined by the first classification model may comprise a binary classification (e.g., “yes/no”), a percentage (e.g., 70%), a numerical value (e.g., 0.7), a combination thereof, and/or the like.

At step 1230, the computing device may determine a mode of the predictions. For example, the first classification model may predict that a frame preceding the first frame and the first frame itself are both indicative of the OOI (e.g., they both depict the OOI). The prediction for a last frame of the 3 video frames may indicate that the last frame is not indicative of the OOI (e.g., the OOI is not depicted). The mode of the predictions may therefore indicate that the OOI is depicted in the group of 3 video frames. The mode of the predictions may be used to label/identify each of the 3 video frames as being indicative of the OOI, regardless of any individual prediction.

The second classification model be a grayscale-oriented model (e.g., a deep-learning model and/or a neural network) that focuses on grayscale-based features of each video frame of the plurality of video frames. The grayscale-based features of each video frame of the plurality of video frames may be derived from the corresponding grayscale channels generated by a color channel transformation module of the computing device. The grayscale channel of each video frame of the plurality of video frames may be indicative of patterns and/or pixel intensity within each video frame of the plurality of video frames.

At step 1240, the computing device may determine a first plurality of grayscale channel features associated with the first frame and a second plurality of grayscale channel features for at least one neighboring frame of the first frame. For example, the second classification model may determine the first plurality of grayscale channel features based on the grayscale channel corresponding to the first frame. The second classification model may determine the second plurality of grayscale channel features based on the grayscale channel corresponding to the frame that precedes first frame and/or the grayscale channel corresponding to the last frame.

The computing device may comprise a post-processing module. The post-processing module may perform a 1-N validation on predictions determined by the first classification model. For example, the post-processing module may perform a 1-N validation on the predictions determined by the first classification model for the first frame. The post-processing module may verify the prediction determined by the first classification model for the first frame of based on the predictions determined by the second classification model for each of the 3 video frames. The prediction determined by the first classification model for the first frame of may be verified by the post-processing module based on the second classification model having determined that the first plurality of grayscale channel features and/or the second plurality of grayscale channel features are indicative of the OOI. In other words, the prediction determined the first classification model for the first frame may nonetheless be verified by the post-processing module because the second classification model determined that the grayscale channel features for at least one neighboring frame were indicative of the OOI.

The computing device may determine/generate a final prediction. The final prediction may indicate that the predictions determined by the first classification model have been validated/verified. For example, the final prediction may indicate that the predictions determined by the first classification model for the 3 video frames are validated/verified when a threshold is satisfied. At step 1250, the computing device may determine that the first prediction satisfies the threshold. For example, the threshold may be satisfied (e.g., the predictions for the 3 video frames may be verified) when the grayscale channel features associated with the at least one neighboring frame of the first frame are indicative of the OOI. The final prediction may comprise a binary classification (e.g., “yes/no”), a percentage (e.g., 70%), a numerical value (e.g., 0.7), a combination thereof, and/or the like. The threshold may be satisfied based on the mode of predictions. For example, the mode of the predictions may indicate that the OOI is depicted in the group of 3 video frames. The threshold may be satisfied when the mode of the predictions indicate that the OOI is depicted in the group of 3 video frames. Other examples are possible as well.

In some examples the first prediction may comprise a first level of confidence (e.g., a percentage) that the OOI is depicted in the first frame, and the first and/or second plurality of grayscale channel features may be associated with a second level of confidence (e.g., a percentage) that the OOI is depicted in the first frame. The first prediction may be verified when the first level of confidence and the second level of confidence both meet or exceed the threshold (e.g., a confidence threshold of 70%). The first prediction may be verified when the first level of confidence by itself meets or exceeds the confidence threshold. The first prediction may be verified when the second level of confidence by itself meets or exceeds the confidence threshold. The first prediction may not be verified when one or both of the first level of confidence or the second level of confidence fail to meet or exceed the confidence threshold. Other combinations are possible as well.

Though the method 1200 is described herein with the first classification model being a color-oriented model and the second classification model being a grayscale-oriented model, it is to be understood that the first classification model may be a grayscale-oriented model and the second classification model may be a color-oriented model. In such examples the method 1200 may proceed in a similar manner as described above, except that the first prediction at step 1220 may be based on grayscale channel features rather than color channel features, the plurality of grayscale channel features associated with the first frame may instead be a plurality of color features associated with the first frame, and so forth.

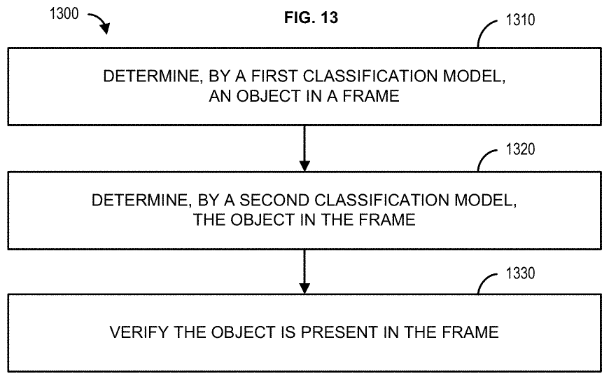

FIG. 13 shows a flowchart of an example method 1300 for improved video frame analysis and classification. The method 1300 may be performed in whole or in part by a single computing device, a plurality of computing devices, and the like. For example, the first user device 104, the second user device 108, the server 102, the computing device 801, and/or the server 802 may be configured to perform the method 1300.

The method 1300 may use a classification model to predict whether a first frame of a plurality of video frames comprises an object of interest (“OOI”). A computing device may receive the plurality of video frames. For example, a pre-processing module of the classification model may receive the plurality of video frames. The plurality of video frames may comprise footage captured by a security camera, a frame of a video clip captured by a user device, a portion(s) of streaming or televised content, a combination thereof, and/or the like. Each video frame of the plurality of video frames may be resized by the pre-processing module. For example, the pre-processing module may resize each video frame of the plurality of video frames to 300×300 pixels. The pre-processing module may perform noise filtering on each video frame of the plurality of video frames. For example, the pre-processing module may perform noise filtering using an anti-aliasing technique. The pre-processing module may extract color channels from each video frame of the plurality of video frames. The color channels may be indicative of red/green/blue (RGB) color channel values for each pixel of each video frame of the plurality of video frames. The pre-processing module may comprise a color channel transformation module that transforms the color channels into a grayscale channel.

The classification model may comprise a classification module. The classification module may comprise a first classification model and a second classification model. The first classification model may be a color-oriented model (e.g., a deep-learning model and/or a neural network) that focuses on color-based features of the plurality of video frames. The first classification model may analyze the plurality of video frames and derive a plurality of color channel features from the color channels associated with the plurality of video frames. For example, the first classification model may derive the plurality of color channel features based on the RGB color channel values for each pixel of each video frame of the plurality of video frames.

The first classification model may analyze a number of video frames selected from the plurality of video frames. For example, the first classification model of the classification module may analyze 3 video frames selected from the plurality of video frames. The 3 video frames may or may not be successive frames within the plurality of video frames. At step 1310, the first classification model may determine an object of interest (“OOI”) being depicted (or not depicted) within the first frame. For example, the first classification model may determine a first prediction indicative of the OOI being depicted (or not depicted) within the first frame. The first frame may be in a second—or middle—position in the plurality of frames in terms of order. The OOI may comprise an object associated with a type of event or particular imagery. For example, the type of event may be an explosion, and the imagery may be a fire, a plume of smoke, glass shattering, a building collapsing, etc. The first classification model may determine the that the OOI is depicted (or not) (e.g., the first prediction) based on the plurality of color channel features corresponding to the first frame. The first classification model may determine a similar prediction regarding the OOI for each of the other frames of the plurality of frames. Each prediction determined by the first classification model may comprise a binary classification (e.g., “yes/no”), a percentage (e.g., 70%), a numerical value (e.g., 0.7), a combination thereof, and/or the like.

A mode of the predictions may be determined by the computing device. For example, the first classification model may predict that a frame preceding the first frame and the first frame itself are both indicative of the OOI (e.g., they both depict the OOI). The prediction for a last frame of the 3 video frames may indicate that the last frame is not indicative of the OOI (e.g., the OOI is not depicted). The mode of the predictions may therefore indicate that the OOI is depicted in the group of 3 video frames. The mode of the predictions may be used to label/identify each of the 3 video frames as being indicative of the OOI, regardless of any individual prediction.

The second classification model be a grayscale-oriented model (e.g., a deep-learning model and/or a neural network) that focuses on grayscale-based features of each video frame of the plurality of video frames. The grayscale-based features of each video frame of the plurality of video frames may be derived from the corresponding grayscale channels generated by a color channel transformation module of the computing device. The grayscale channel of each video frame of the plurality of video frames may be indicative of patterns and/or pixel intensity within each video frame of the plurality of video frames. At step 1320, the computing device may determine that the OOI is depicted (or not depicted) within the first frame. The computing device may determine that the OOI is depicted (or not depicted) within the first frame based on a first plurality of grayscale channel features associated with the first frame. The computing device may use the second classification model to determine the first plurality of grayscale channel features. The computing device may use the second classification model to determine a second plurality of grayscale channel features. For example, the computing device (e.g., the second classification model) may determine the first plurality of grayscale channel features based on the grayscale channel corresponding to the first frame. The computing device may determine the second plurality of grayscale channel features for at least one neighboring frame of the first frame. The at least one neighboring frame may precede or follow the first frame. For example, the second classification model may determine the second plurality of grayscale channel features based on the grayscale channel corresponding to the frame that precedes first frame and/or the grayscale channel corresponding to the last frame.

The computing device may comprise a post-processing module. The post-processing module may perform a 1-N validation on predictions determined by the first classification model. For example, the post-processing module may perform a 1-N validation on the predictions determined by the first classification model for the first frame. The post-processing module may verify the prediction determined by the first classification model for the first frame of based on the predictions determined by the second classification model for each of the 3 video frames. The prediction determined by the first classification model for the first frame of may be verified by the post-processing module based on the second classification model having determined that the first plurality of grayscale channel features and/or the second plurality of grayscale channel features are indicative of the OOI. In other words, the prediction determined the first classification model for the first frame may nonetheless be verified by the post-processing module because the second classification model determined that the grayscale channel features for at least one neighboring frame were indicative of the OOI.

The computing device may determine/generate a final prediction. The final prediction may indicate that the predictions determined by the first classification model have been validated/verified. For example, the final prediction may indicate that the predictions determined by the first classification model for the 3 video frames are validated/verified when a threshold is satisfied. The final prediction may comprise a binary classification (e.g., “yes/no”), a percentage (e.g., 70%), a numerical value (e.g., 0.7), a combination thereof, and/or the like.

At step 1330, the computing device may verify that the OOI is depicted (or not depicted) within the first frame. For example, the computing device may verify that the OOI is depicted (or not depicted) within the first frame by determining that the first prediction satisfies the threshold. The threshold may be satisfied (e.g., the first prediction may be verified) when the first plurality of grayscale channel features associated with the first frame are indicative of the OOI. The threshold may be satisfied when the second plurality of grayscale channel features associated with the at least one neighboring frame are indicative of the OOI.

In some examples the first prediction may comprise a first level of confidence (e.g., a percentage) that the OOI is depicted in the first frame, and the first and/or second plurality of grayscale channel features may be associated with a second level of confidence (e.g., a percentage) that the OOI is depicted in the first frame. The first prediction may be verified when the first level of confidence and the second level of confidence both meet or exceed the threshold (e.g., a confidence threshold of 70%). The first prediction may be verified when the first level of confidence by itself meets or exceeds the confidence threshold. The first prediction may be verified when the second level of confidence by itself meets or exceeds the confidence threshold. The first prediction may not be verified when one or both of the first level of confidence or the second level of confidence fail to meet or exceed the confidence threshold. Other combinations are possible as well

Though the method 1300 is described herein with the first classification model being a color-oriented model and the second classification model being a grayscale-oriented model, it is to be understood that the first classification model may be a grayscale-oriented model and the second classification model may be a color-oriented model. In such examples the method 1300 may proceed in a similar manner as described above, except that the first prediction at step 1310 may be based on grayscale channel features rather than color channel features, the plurality of grayscale channel features associated with the first frame may instead be a plurality of color features associated with the first frame, and so forth.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
determining, by a first classification model and based on a plurality of color features associated with a frame of video, an object in the frame;
determining, by a second classification model and based on a plurality of greyscale features associated with the frame, the object in the frame; and
based on the determination of the object in the frame by the first classification model and the second classification model, verifying the object is present in the frame.

2. The method of claim 1, wherein determining the object in the frame comprises determining, based on the first classification model and the plurality of color features, a prediction that the frame comprises the object.

3. The method of claim 1, wherein the video is associated with at least one of: a content provider, a user device, or a security camera.

4. The method of claim 1, further comprising: transforming the plurality of color features into the plurality of grayscale features.

5. The method of claim 1, wherein determining the plurality of grayscale features comprises: determining, based on at least one neighboring frame, the plurality of grayscale features.

6. The method of claim 5, wherein the at least one neighboring frame comprises a first neighboring frame that precedes the frame and a second neighboring frame that follows the frame, and wherein at least one color feature of the first neighboring frame partially differs from at least one color feature of the second neighboring frame.

7. The method of claim 1, wherein verifying the object is present in the frame comprises at least one of:
determining that the plurality of grayscale features are indicative of the frame comprising the object; or
determining that the plurality of grayscale features are indicative of at least one neighboring frame comprising the object.

8. A method comprising:
determining, based on a plurality of color features associated with a first frame of video, a prediction associated with an object in the first frame;
determining a first plurality of grayscale features associated with the frame and a second plurality of grayscale features associated with at least one neighboring frame of the first frame; and
verifying, based on at least one of: the first plurality of grayscale features or the second plurality of grayscale features, the prediction.

9. The method of claim 8, wherein determining the prediction associated with the object in the frame comprises:
determining, based on a first deep-learning model and the plurality of color features, the prediction, wherein the first deep-learning model is configured to detect the object in frames of video.

10. The method of claim 8, wherein the video is associated with at least one of: a content provider, a user device, or a security camera.

11. The method of claim 8, wherein the object comprises an explosion, a flame, or smoke.

12. The method of claim 8, wherein determining the first plurality of grayscale features comprises: transforming the plurality of color features into the first plurality of grayscale features, and wherein determining the second plurality of grayscale features comprises transforming at least one plurality of color features associated with the at least one neighboring frame into the second plurality of grayscale features.

13. The method of claim 8, wherein the at least one neighboring frame comprises a first neighboring frame that precedes the first frame and a second neighboring frame that follows the first frame, and wherein the first neighboring frame is associated with a plurality of color features that at least partially differs from a plurality of color features associated with the second neighboring frame.

14. The method of claim 8, wherein verifying the prediction comprises at least one of:
determining that the first plurality of grayscale features are indicative of the first frame comprising the object; or
determining that the second plurality of grayscale features are indicative of the at least one neighboring frame comprising the object.

15. A method comprising:
determining, based on a plurality of color features associated with a first frame of video, a prediction associated with an object in the first frame;
determining, based on the plurality of color features, a plurality of grayscale features associated with the first frame; and
verifying, based on the plurality of grayscale features, the prediction.

16. The method of claim 15, wherein determining the prediction comprises:
determining, based on a deep-learning model and the plurality of color features, the prediction, wherein the deep-learning model is configured to detect the object in frames of video based on color features.

17. The method of claim 15, wherein verifying the prediction comprises:
determining, based on a deep-learning model and the plurality of grayscale features, a second prediction, wherein the deep-learning model is configured to detect the object in frames of video based on grayscale features.

18. The method of claim 17, wherein the second prediction is indicative of the first frame comprising the object.

19. The method of claim 15, wherein the first frame is associated with at least one of:
video associated with a content provider, video associated with a user device, or video associated with a security camera.

20. The method of claim 15, wherein determining the plurality of grayscale features comprises: transforming the plurality of color features into the plurality of grayscale features.
